(19) United States
(12) Patent Application Publication
(10) Pub. No.: US 2026/0219080 A1
(43) Pub. Date: Jul. 30, 2026

(54) Fastening system

(71) Applicant: SICK AG, Waldkirch (DE)

(72) Inventor: Jochen SCHOLDER, Waldkirch (DE)

(21) Appl. No.: 19/454,938

(22) Filed: Jan. 21, 2026

(30) Foreign Application Priority Data
Jan. 24, 2025 (EP) 25153713.0

(51) Int. Cl. G01D 11/30; F16B 2/20

(52) U.S. Cl. CPC G01D 11/305; F16B 2/20

(57) ABSTRACT

A fastening system for fastening a sensor to a wall includes an installation frame having a plug-in section for a plugging into an opening of the wall and an abutment section for abutting of the installation frame at a margin of the opening at a first side of the wall. A sensor snap-in hook is arranged at the installation frame, movable between a latch position and a release position, and latchable to a step of the sensor. The fastening system includes a fixing frame that is configured to pull the abutment section, while being supported at a second side of the wall, toward the first side of the wall in order to hold the installation frame at the wall. The fixing frame can be coupled to the installation frame and is configured to engage behind the sensor snap-in hook in the coupled state.

The invention relates to a fastening system for fastening a sensor to a wall, said fastening system comprising an installation frame that has a plug-in section for a plugging into an opening of the wall and an abutment section, which projects with respect to the plug-in section, for an abutting of the installation frame at a margin of the opening at a first side of the wall, wherein at least one sensor snap-in hook is arranged at the installation frame, said sensor snap-in hook being movable between a latch position and a release position and being latchable to a step of the sensor in order to hold the sensor at the installation frame.

Sensors that are to be used in a stationary position are often attached to walls such as control panels, metal sheets or housing parts. For this purpose, an opening into which the housing of the sensor can be inserted can be formed in the respective wall. For this purpose, the installation frame of a fastening system as specified above is inserted into the opening from the front, for example. Subsequently, the sensor is, for example, moved in the opposite direction towards the installation frame and is latched thereto. The unit formed by the installation frame and the sensor must then also be fastened to the wall. This can take place by screwing, for example. However, special tools are required for the assembly in this case, which is generally undesirable. The screw connection can furthermore be released by vibrations. The latching connection between the installation frame and the sensor can also be released so that the sensor falls backwards out of the installation frame if, for example, a button present at the front side of the sensor housing is pressed too hard. A further problem is that the installation frame can be damaged if the screws are tightened too much.

There is the desire for a fastening system that enables a simple, cost-effective, tool-free and stable assembly of a sensor in an opening of a wall.

The object is satisfied by a fastening system having the features of claim 1.

A fastening system according to the invention comprises a fixing frame that is configured to pull the abutment section of the installation frame, while being supported at a second side of the wall facing away from the first side of the wall, toward the first side of the wall in order to hold the installation frame at the wall, wherein the fixing frame can be coupled to the installation frame and is configured to engage behind the at least one sensor snap-in hook in the coupled state and, as a result, to secure said sensor snap-in hook in the latch position.

In the assembled state, the installation frame fixedly contacts the wall so that it cannot fall out of the opening. The sensor is securely held at the installation frame, and thus likewise at the wall, via the sensor snap-in hook. A release of the latching connection between the installation frame and the sensor is prevented by the fixing frame. Thus, the fixing frame fulfills a dual function by holding the installation frame at the wall, on the one hand, and securing the sensor to the installation frame, on the other hand. The provision of tools is not absolutely necessary for the assembly. Since the sensor snap-in hook is engaged behind by the fixing frame, there is no risk of the sensor being released from the holder, even in the event of vibrations and impacts.

The sensor can be a pressure sensor. In particular in process technology, pressure sensors have to be installed in control panels relatively frequently. Preferably, the sensor has an at least substantially cuboid-shaped housing. The step can, for example, be formed by a margin of such a cuboid-shaped housing. However, the sensor can generally also have a housing that has an attachment shoulder at any desired position, which attachment shoulder can be engaged around by the sensor snap-in hook for the latching engagement.

The abutment section of the installation frame preferably extends around the plug-in section so that a stable contact of the installation frame at the wall is made possible.

Preferably, the installation frame and/or the fixing frame is/are made of plastic. In particular, the installation frame and/or the fixing frame can be designed as injection-molded parts to enable a simple and cost-effective manufacture. If it is sensible, for example, based on special stability requirements, the installation frame and/or the fixing frame can also be made of sheet metal.

Preferably, at least one spring element is arranged at the fixing frame and can be preloaded by a movement of the fixing frame in the direction of the second side of the wall. For example, when the fixing frame is moved towards the second side of the wall, a free end of a compression spring element abuts the wall so that the compression spring element is compressed. The preloaded spring element pulls the abutment section of the installation frame toward the first side of the wall and thus fixes the installation frame in the opening, wherein a relatively high variance in the thickness of the wall is permissible.

The spring element can be latched to a base part of the fixing frame so that it can be removed from the base part, if necessary. Alternatively, the fixing frame can be designed as a single-piece injection-molded part together with the spring element. Depending on the application, the base part and the spring element can be made from the same material or from different materials. A specific embodiment of the invention provides that the base part of the fixing frame is made of plastic and the spring element is made of sheet metal, or vice versa.

According to one embodiment of the invention, respective spring elements are arranged at two opposite marginal regions of the fixing frame and can be preloaded by a movement of the fixing frame in the direction of the second side of the wall. The spring force is thereby distributed over the abutment section of the installation frame so that the latter lies firmly all around the first side of the wall.

The fixing frame and the spring elements can be formed by an assembly comprising different components. A specific embodiment in this respect provides that the spring elements are made of a different material than the fixing frame. For example, the spring elements can be made of a comparatively elastic material, while the fixing frame is made of a comparatively rigid material. However, for a simplified design, provision can also be made that the spring elements are made of the same material as the fixing frame.

According to a further embodiment of the invention, the fixing frame and the spring elements are formed by a component with a uniform material.

A further embodiment of the invention provides that the fixing frame has at least one sliding guide section along which the fixing frame can be pushed onto the installation frame in a sliding direction. The guided sliding movement makes the assembly easier.

The at least one sliding guide section is preferably designed and arranged such that it is guided at the sensor snap-in hook on the pushing onto the installation frame. In this embodiment, the sensor snap-in hook, for example a planar rear hook side, forms the counter-guide surface for the sliding guide section.

A further embodiment of the invention provides that two sensor snap-in hooks movable in opposite directions are arranged at the installation frame and the fixing frame has two rail-shaped sliding guide sections that extend parallel to one another and that are designed and arranged such that, on the pushing onto the installation frame, they are guided at the sensor snap-in hooks movable in opposite directions. The installation frame is in this respect engaged around at two sides via its sensor snap-in hooks.

The installation frame and the fixing frame are preferably designed such that the sensor snap-in hook that is in the latch position is blocked by the at least one sliding guide section when the fixing frame is pushed onto the installation frame. This enables a particularly simple design in which the sensor snap-in hook is automatically engaged behind by the fixing frame on the pushing of the fixing frame onto the installation frame, and Is thus blocked. This means that the sliding guide section serves both to guide the fixing frame on the pushing onto the installation frame and to secure the sensor snap-in hook because the sliding guide section contacts the sensor snap-in hook and thus prevents a releasing movement of the sensor snap-in hook.

According to a specific embodiment of the invention, the fixing frame has at least one engagement rib, which extends transversely to the sliding direction, for an engagement into an assembly groove of the sensor. The engagement rib serves as an abutment on the pushing of the fixing frame onto the installation frame and furthermore secures the fixing frame at the sensor via the assembly groove.

A further embodiment of the invention provides that the at least one engagement rib has a thickness of 0.7 mm to 1.2 mm, preferably of approximately 1 mm. This embodiment is advantageous in that many existing sensors are designed for a top-hat rail assembly and are for this purpose provided with a groove of a thickness of approximately 1 mm at the housing-a common thickness of top-hat rails. In a fastening system according to the invention, such a groove that is present anyway can advantageously be used as an assembly groove for the cooperation with an engagement rib. From a sensor manufacturer's point of view, it is advantageous that one and the same sensor is suitable for both a top-hat rail assembly and a control panel assembly.

The fixing frame can have at least one guide projection that engages into at least one holding claw of the sensor when the sensor is held at the installation frame and the fixing frame is pushed onto the installation frame. This ensures a secure hold of the fixing frame at the sensor.

A latching tongue can be arranged at the fixing frame and engages into a counter-latch of the sensor when the sensor is held at the installation frame and the fixing frame is pushed onto the installation frame. An unwanted automatic pushing back, for example as a result of vibrations, is thereby ruled out so that the hold of the fixing frame at the installation frame is improved. For a desired removal of the fixing frame, the latching tongue can, for example, be moved against the spring force into its release position by means of a tool. A handling projection can be arranged at the latching tongue, for example in the form of a comb or a rib, to facilitate the movement of the latching tongue into its release position, possibly even without tools.

According to a further embodiment, the fastening system comprises a securing element that can be plugged into a receiver of the fixing frame and that blocks a movement of the fixing frame pushed onto the installation frame against the sliding direction in the plugged-in state. This ensures a further stabilized hold of the fixing frame at the sensor and at the installation frame. The securing element can be designed like a holding clip and can have latching elements for a latching with the fixing frame.

It is preferred that the securing element secures the latching tongue in its latch position in the plugged-in state. For example, the securing element can press against the rear side of the latching tongue in the plugged-in and preferably latched state. The reliability of the fastening is hereby further improved.

Provision can be made that the installation frame defines a receiving space for a housing of the sensor and the at least one sensor snap-in hook engages around the receiving space when said sensor snap-in hook is in the latch position. Such a fastening system is suitable for all sensor types that have a housing with the size and the shape of the receiving space. It is understood that the receiving space can be adapted to a specific type of sensor housing.

A further embodiment of the invention provides that the receiving space is cuboid-shaped and four sensor snap-in hooks are arranged at the installation frame that are each movable between a latch position and a release position and that engage around respective corner regions of one side of the receiving space in the latch position. This takes into account the circumstance that many sensors, in particular pressure sensors, have cuboid-shaped or cubic housings.

The invention also relates to a sensor system comprising a sensor, for example a pressure sensor, and a fastening system as described above, wherein the fastening system is configured to fasten the sensor to the wall.

Further developments of the invention can also be seen from the dependent claims, from the description and from the enclosed drawings.

The invention will be described in the following by way of example with reference to the drawings.

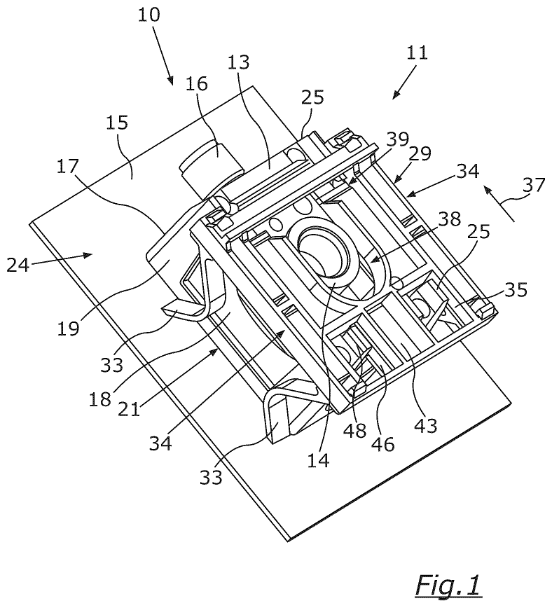

FIG. 1 shows a fastening system according to the invention in which a fixing frame of the fastening system is in a starting position;

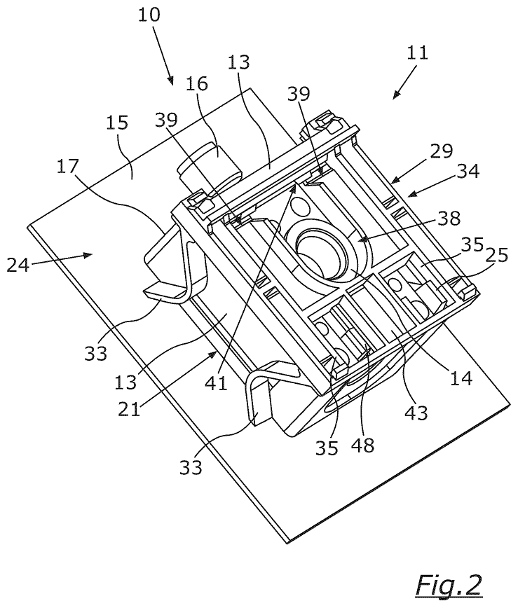

FIG. 2 shows the fastening system in accordance with FIG. 1, wherein the fixing frame is in an end position;

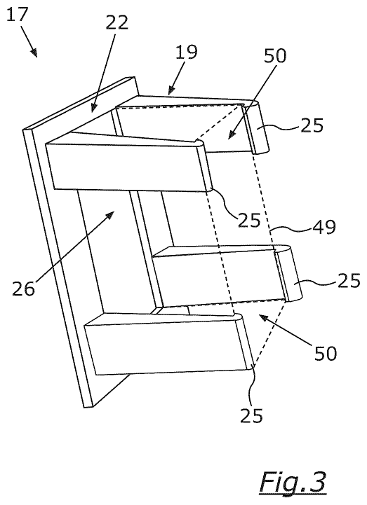

FIG. 3 shows an installation frame of the fastening system in accordance with FIG. 1 in a perspective individual view;

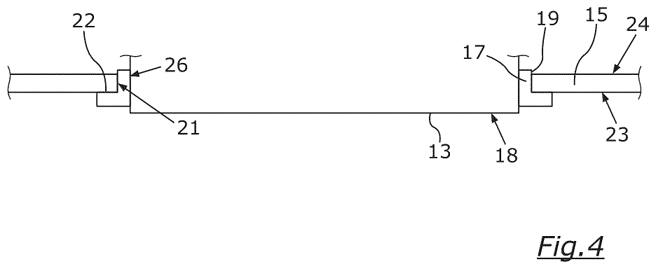

FIG. 4 is a lateral sectional view of a sensor that is held in an opening of a wall by a fastening system according to the invention;

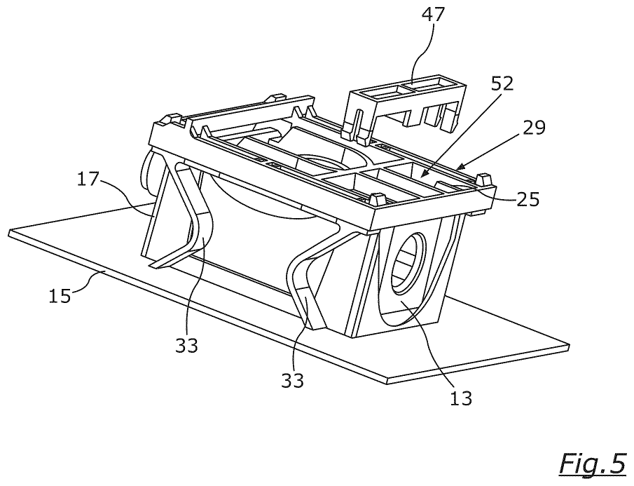

FIG. 5 shows the fastening system in accordance with FIG. 1 together with a securing element;

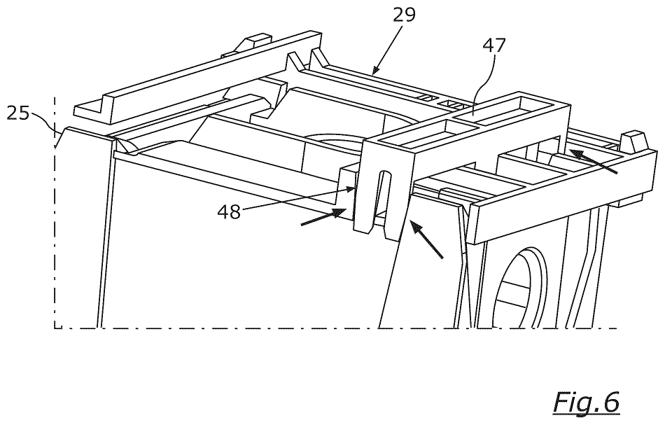

FIG. 6 is a partial representation of the arrangement shown in FIG. 5 with the securing element located in a fixing position;

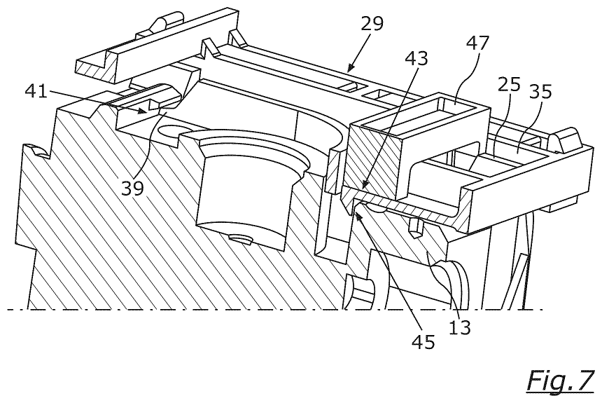

FIG. 7 is a partial sectional representation of the fastening system in accordance with FIG. 1 that shows the engagement of a latching tongue with a sensor housing.

The sensor system 10 shown in FIGS. 1 and 2 that is designed according to one embodiment of the invention comprises a sensor 13 and a fastening system 11 according to the invention for fastening the sensor 13 to a wall 15 such as, for example, a control panel. In the embodiment example shown, the sensor 13 is configured as a pressure sensor and accordingly has at least one pressure connection 14 for connecting a pressure-conducting line and an electrical terminal 16 for supplying the sensor 13 with electrical energy and for outputting a pressure signal. The housing 18 of the sensor 13 is at least substantially cuboid-shaped.

The fastening system 11 comprises an installation frame 17 that is shown in an individual representation in FIG. 3. The installation frame 17, which is preferably designed as a plastic injection-molded part, comprises a plug-in section 19 that serves for the plugging into an opening 21 (FIG. 1) of the wall 15 and that is preferably adapted to a predefined opening 21 in terms of its cross-sectional shape and cross-sectional size. An abutment section 22 projecting laterally with respect to the plug-in section 19 is provided for an abutting of the installation frame 17 at a margin of the opening 21 at a first side 23 of the wall 15, as is shown in FIG. 4. The abutment section 22 extends around a central frame opening 26 of the installation frame 17. An arrangement of four spring-loaded sensor snap-in hooks 25 is furthermore provided at the installation frame 17, said sensor snap-in hooks 25 each being movable between a latch position and a release position.

As can be seen in FIG. 3, due to the abutment section 22 and the sensor snap-in hooks 25, a receiving space 49 of the installation frame 17 is formed, in which the housing 18 of the sensor 13 can be accommodated. For this purpose, the sensor 13 can be introduced between the sensor snap-in hooks 25, wherein the sensor snap-in hooks 25 engaging around the receiving space 49 latch with the housing 18 of the sensor 13 and thereby hold the sensor 13 at the installation frame 17.

In the embodiment shown, the receiving space 49 is cuboid-shaped and the four sensor snap-in hooks 25 engage in their latch positions around the rear corner regions 50 of the receiving space 49. However, the receiving space 49 can also have a different shape in dependence on the sensor 13 to be received.

Referring again to FIGS. 1 and 2, a fixing frame 29 of the fastening system 11 is described below. The fixing frame 29 is preferably configured as a plastic injection-molded part or is composed of a plurality of plastic injection-molded parts and has respective spring elements 33, here in the form of curved strips of an elastic material, at two opposite marginal regions 34.

Furthermore, two rail-shaped sliding guide sections 35 are formed at the fixing frame 29 and extend parallel to one another in a sliding direction 37. Furthermore, two guide projections 46, here plate-like guide projections, which likewise extend in the sliding direction 37, are formed at the fixing frame 29. They are configured for a sliding guidance in holding claws 48 that are arranged at the housing 18 of the sensor 13. The holding claws 48 are formed by angled strips or plates and face towards one another with their openings. An engagement rib 39 of the fixing frame 29 extends transversely to the sliding direction 37, is adapted to an assembly groove 41 of the sensor 13 and preferably has a thickness of approximately 1 mm. As shown, the engagement rib 39 is interrupted here and extends at both sides of a recess 38 of the fixing frame 29, which recess 38 is provided to receive the pressure connection 14 of the sensor 13. Between the two sliding guide sections 35 there is a latching tongue 43 that is resiliently movable transversely to the sliding direction 37 and transversely to the course of the engagement rib 39.

For the assembly of the sensor 13, the installation frame 17 is first inserted into the opening 21 by guiding the plug-in section 19 through the opening 21 from the front until the abutment section 22 abuts the first side 23 of the wall 15. The sensor 13 is then inserted into the installation frame 17, with the sensor snap-in hooks 25 latching in at the housing 18 of the sensor 13 and holding the latter at the installation frame 17. The housing 18 can partly project through the frame opening 26, as shown in FIG. 4. Preferably, an abutment, not shown in the Figures, is provided at the housing 18 of the sensor 13 and prevents the sensor 13 from passing through the frame opening 26.

Then, as shown in FIG. 1, the fixing frame 29 is placed onto the unit of the installation frame 17 and the sensor 13 while the spring elements 33 are preloaded, wherein the pressure connection 14 of the sensor 13 enters the recess 38 and the sliding guide sections 35 enter into a contact with the sensor snap-in hooks 25. Then, the fixing frame 29, while being guided by the sliding guide sections 35 at the sensor snap-in hooks 25, is pushed onto the installation frame 17 in the sliding direction 37 until the end position shown in FIG. 2 is reached, in which the engagement rib 39 engages into the assembly groove 41 of the sensor 13, the guide projections 46 are engaged around by the holding claws 48 of the sensor 13 and the latching tongue 43, as can be seen in FIG. 7, is snapped into a counter-latch 45 of the sensor 13.

In the end position of the fixing frame 29, it is coupled to the sensor 13 via the engagement rib 39 and the guide projections 46. The spring elements 33 are supported at the second side 24 of the wall 15 and ensure that the abutment section 22 of the installation frame 17 is pulled toward the first side 23 of the wall 15, whereby the installation frame 17 is fixedly held at the wall 15.

In an embodiment, not shown, instead of the spring elements 33, threaded bushings are provided at the fixing frame, into which threaded bushings clamping screws can be screwed and which are aligned such that the screwed-in clamping screws can be supported with their screw tip at the second side 24 of the wall 15. A similar effect as by the spring elements 33 can thereby be achieved. The heads of the clamping screws can be fitted with wings or levers so that no use of tools is necessary for the clamping.

Since the fixing frame 29 is held in a form-fitted manner at the sensor 13 in its end position and the housing 18 of the sensor 13 is coupled to the installation frame 17 via the sensor snap-in hooks 25, there is a fixed connection between the fixing frame 29 and the installation frame 17. As can be seen in FIG. 2, in the coupled state, the sliding guide sections 35 contact the rear sides of the sensor snap-in hooks 25 so that the latter cannot move into their bent-back release positions. This means that the sensor snap-in hooks 25 are engaged behind by the sliding guide sections 35 and are thereby secured in their latch positions. An unlatching movement of the sensor snap-in hooks 25 is blocked and a release of the latching connection is thus reliably prevented. A pushing back of the fixing frame 29 against the sliding direction 37 into the starting position in accordance with FIG. 1 is likewise prevented because the latching tongue 43 engages into the counter-latch 45 of the sensor 13. Even pronounced vibrations and impacts cannot release the sensor 13 from the wall 15 during the operation.

If the sensor 13 is to be released from the wall 15, for example for maintenance or repair, the latching tongue 43 is lifted slightly by means of a screwdriver or similar and the fixing frame 29 is displaced against the sliding direction 37 until the guide projections 46 have moved out of the holding claws 48 and the engagement rib 39 has moved out of the assembly groove 41. The fixing frame 29 can then be removed from the installation frame 17 to the rear and the sensor 13 can be removed from the installation frame 17, if necessary, by slightly bending back some or all of the sensor snap-in hooks 25.

A securing element 47 of the fastening system 11 that can be used for particularly high stability requirements is shown in FIGS. 5-7. The clamp-like securing element 47 can be plugged into a receiver 52 of the fixing frame 29. In the plugged-in state, a movement of the fixing frame 29 pushed onto the installation frame 17 in and in particular against the sliding direction 37 is then blocked, as is indicated by arrows in FIG. 6. As can be seen in FIG. 7, the latching tongue 43 is also blocked when the securing element 47 is plugged into the receiver 52. The securing element 47 therefore has a dual securing function here.

The fastening system 11 enables a fast and tool-free assembly of the sensor 13 in the opening 21 of the wall 15 using simple means, which meets high stability requirements.

### REFERENCE NUMERAL LIST

10 sensor system
11 fastening system
13 sensor
14 pressure connection
15 wall
16 electrical terminal
17 installation frame
18 housing
19 plug-in section
21 opening
22 abutment section
23 first side
24 second side
25 sensor snap-in hooks
26 frame opening
29 fixing frame
33 spring element
35 sliding guide section
37 sliding direction
38 recess
39 engagement rib
41 assembly groove
43 latching tongue
45 counter-latch
46 guide projection
47 securing element
48 holding claw
49 receiving space
50 corner region
52 receiver

1. A fastening system for fastening a sensor to a wall, said fastening system comprising an installation frame that has a plug-in section for a plugging into an opening of the wall and an abutment section, which projects with respect to the plug-in section, for an abutting of the installation frame at a margin of the opening at a first side of the wall,
wherein at least one sensor snap-in hook is arranged at the installation frame, said sensor snap-in hook being movable between a latch position and a release position and being latchable to a step of the sensor in order to hold the sensor at the installation frame,
wherein the fastening system comprises a fixing frame that is configured to pull the abutment section of the installation frame, while being supported at a second side of the wall facing away from the first side of the wall, toward the first side of the wall in order to hold the installation frame at the wall,
wherein the fixing frame can be coupled to the installation frame and is configured to engage behind the at least one sensor snap-in hook in the coupled state and, as a result, to secure said sensor snap-in hook in the latch position.

2. The fastening system according to claim 1,
wherein at least one spring element is arranged at the fixing frame and can be preloaded by a movement of the fixing frame in the direction of the second side of the wall.

3. The fastening system according to claim 2,
wherein respective spring elements are arranged at two opposite marginal regions of the fixing frame and can be preloaded by a movement of the fixing frame in the direction of the second side of the wall.

4. The fastening system according to claim 1,
wherein the fixing frame has at least one sliding guide section along which the fixing frame can be pushed onto the installation frame in a sliding direction.

5. The fastening system according to claim 4,
wherein the at least one sliding guide section is designed and arranged such that it is guided at the sensor snap-in hook on the pushing onto the installation frame.

6. The fastening system according to claim 5,
wherein two sensor snap-in hooks movable in opposite directions are arranged at the installation frame and the fixing frame has two rail-shaped sliding guide sections that extend parallel to one another and that are designed and arranged such that, on the pushing onto the installation frame, they are guided at the sensor snap-in hooks movable in opposite directions.

7. The fastening system according to claim 5,
wherein the installation frame and the fixing frame are designed such that the sensor snap-in hook that is in the latch position is blocked by the at least one sliding guide section when the fixing frame is pushed onto the installation frame.

8. The fastening system according to claim 4,
wherein the fixing frame has at least one engagement rib, which extends transversely to the sliding direction, for an engagement into an assembly groove of the sensor.

9. The fastening system according to claim 8,
wherein the at least one engagement rib has a thickness of 0.7 mm to 1.2 mm.

10. The fastening system according to claim 9,
wherein the at least one engagement rib has a thickness of approximately 1 mm.

11. The fastening system according to claim 4,
wherein the fixing frame has at least one guide projection that engages into at least one holding claw of the sensor when the sensor is held at the installation frame and the fixing frame is pushed onto the installation frame.

12. The fastening system according to claim 4,
wherein a latching tongue is arranged at the fixing frame and engages into a counter-latch of the sensor when the sensor is held at the installation frame and the fixing frame is pushed onto the installation frame.

13. The fastening system according to claim 4,
wherein the fastening system comprises a securing element that can be plugged into a receiver of the fixing frame and that blocks a movement of the fixing frame pushed onto the installation frame against the sliding direction in the plugged-in state.

14. The fastening system according to claim 12,
wherein the fastening system comprises a securing element that can be plugged into a receiver of the fixing frame and that blocks a movement of the fixing frame pushed onto the installation frame against the sliding direction in the plugged-in state, and wherein the securing element secures the latching tongue in its latch position in the plugged-in state.

15. The fastening system according to claim 1,
wherein the installation frame defines a receiving space for a housing of the sensor and the at least one sensor snap-in hook engages around the receiving space when said sensor snap-in hook is in the latch position.

16. The fastening system according to claim 15,
wherein the receiving space is cuboid-shaped and four sensor snap-in hooks are arranged at the installation frame that are each movable between a latch position and a release position and that engage around respective corner regions of one side of the receiving space in the latch position.

17. A sensor system comprising a sensor, and a fastening system for fastening a sensor to a wall, said fastening system comprising an installation frame that has a plug-in section for a plugging into an opening of the wall and an abutment section, which projects with respect to the plug-in section, for an abutting of the installation frame at a margin of the opening at a first side of the wall,
wherein at least one sensor snap-in hook is arranged at the installation frame, said sensor snap-in hook being movable between a latch position and a release position and being latchable to a step of the sensor in order to hold the sensor at the installation frame,
wherein the fastening system comprises a fixing frame that is configured to pull the abutment section of the installation frame, while being supported at a second side of the wall facing away from the first side of the wall, toward the first side of the wall in order to hold the installation frame at the wall,
wherein the fixing frame can be coupled to the installation frame and is configured to engage behind the at least one sensor snap-in hook in the coupled state and, as a result, to secure said sensor snap-in hook in the latch position, and wherein the fastening system is configured to fasten the sensor to the wall.

18. The sensor system according to claim 17, wherein the sensor is a pressure sensor.
